(19) United States
(12) Patent Application Publication
(10) Pub. No.: US 2004/0227976 A1
(43) Pub. Date: Nov. 18, 2004

(54) Masks in image processing

(76) Inventors: Vladimir Pavlov, San Diego, CA (US); Yonggui Mao, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/438,659

(22) Filed: May 15, 2003

(51) Int. Cl. G06K 15/02; H04N 1/387; H04N 1/38

(52) U.S. Cl. 358/1.18; 358/453; 382/283

(57) ABSTRACT

Methods, devices and architectures are provided for masks in image processing. One method for masks in image processing includes parameterizing a geometric form representing a print media shape and generating a bitmap from the parameterized geometric form.

In many printing systems, with nonstandard, nonrectangular predefined media shapes, one process is “masking” the initial image, which could be a “standard page” (e.g. 8½×11 inches), to match the media shape. One example of the need for masking is in printing an image to a compact disk (CD), digital versatile disk (DVD), and/or identity (ID) card. Typically, in these instances an initial image created by any application has to be “trimmed” to fit the media to which the image is being applied. The image is trimmed based on the size, the shape, and the desired “printing area” (which may be less than the entire area of the media) for each case. An initial image can be trimmed as part of a masking process. The masking process may create a “mask pattern” which limits placement of the initial image to the desired printing area. In some instances, a mask pattern is created from a bitmap or a bitmap file. A bitmap can provide a description of the image. A bitmap file includes additional information, such as headers. However, use of a bitmap or bitmap file for image masking processes is currently done only at the specific applications level using predefined static bitmaps for a collection of specific shapes and resolutions. Significant memory is required to store these bitmaps or bitmap files.

Some “canned”, commercially available solutions for the mask process include templates or static predefined sets of masks available in applications such as Wordperfect or Adobe Photoshop. Again, however, such static predefined sets of bitmaps can not cover the myriad of print media sizes, shapes, and uses, nor can they address or precision to a particular printing area within a particular media shape. Static predefined mask patterns do not allow a user to precision, e.g. adjust, the mathematical, geometric dimensions of the mask pattern. According to the static approach, the predefined bitmaps are specific to particular applications and often to specified resolutions only.

Changing the bitmaps or bitmap files currently is a time intensive process. That is, a predefined mask is created only for specific display area applications, and to be able to further precision or alter the masking process requires extensive manual work, sometimes through trial and error, e.g. making the additional changes after printing a test run. All of this can result in a higher average printing cost per page, or print media, due to the multiple test prints.

Furthermore, where a user interface or template is necessitated the masking process is restricted from being used in automated and/or “embedded” printing systems.

### BRIEF DESCRIPTION OF THE DRAWINGS

FIG. 1 is a system or network in which embodiments can be implemented.

FIGS. 2A-2C illustrate a series of parameter configuration embodiments for generating bitmaps in a masking process.

FIGS. 3A-3C illustrate a series of parameter variables for various embodiments.

FIGS. 4A-4C illustrate embodiments of a bitmap used to configure images on print media.

FIG. 5 illustrates an embodiment of a system architecture for generating bitmaps.

### DETAILED DESCRIPTION

Various embodiments include converting mathematical descriptions, e.g. parameterized geometric forms, of a desired masking area to a monochrome bitmap or a bitmap file. The bitmap or bitmap file can be used as a mask pattern in a masking process. The various embodiments facilitate the generation of nonrectangular printing images as needed in particular printing applications, e.g. such as in CD, DVD, and ID card printing systems. The various embodiments provide for dynamically creating a bitmap, and in some instances a bitmap file. The dynamically created bitmap and/or bitmap file can be used as a mask pattern and can be applied to format a precise printing area and to position a final image, among other uses. In some embodiments, a preview of an image as it will actually appear on a particular media, according to the mask pattern, can be obtained.

As one of ordinary skill the art will understand, the embodiments can be performed by software, application modules, and computer executable instructions operable on the systems and devices shown herein or otherwise. The invention, however, is not limited to any particular operating environment or to software written in a particular programming language. Software, application modules and/or computer executable instructions, suitable for carrying out embodiments of the present invention, can be resident in one or more devices or locations or in several and even many locations.

Unless explicitly stated, the method embodiments described herein are not constrained to a particular order or sequence. Additionally, some of the described method embodiments can occur or be performed at the same point in time.

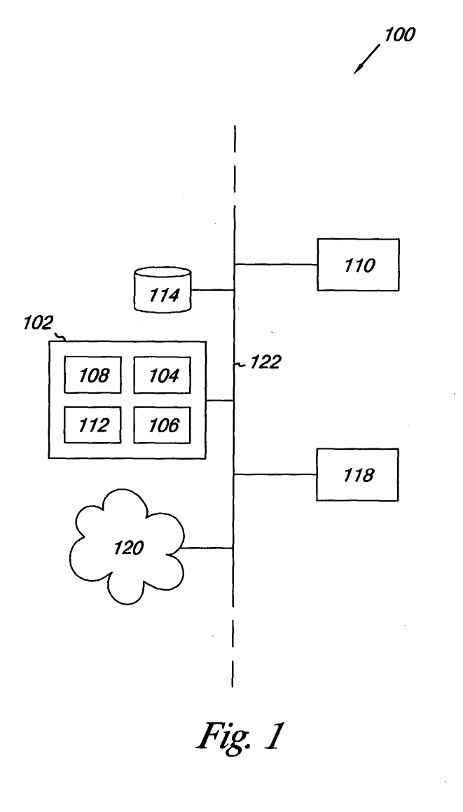

FIG. 1 illustrates a system environment 100 according to various embodiments of the present invention. As shown in FIG. 1, the system includes a printing device 102, such as a surface printer. With regard to the various embodiments of the invention that can be utilized with a system, such as the system 100 shown in FIG. 1, the printing device 102 is operable to print onto print media, substrates, and surfaces of various nature.

The system 100 is operable to receive data and interpret the data to position an image in a particular image position. The system 100 can include software and/or application modules thereon for receiving and interpreting data in order to achieve the positioning and/or formatting functions. As one of ordinary skill in the art will appreciate, the software and/or application modules can be located on any device that is directly or indirectly connected to the printing device 102 within the system 100.

In various embodiments, including the embodiment shown in FIG. 1, the printing device 102 can include one or more processors 104 and one or more memory devices 106. The one or more processors 104 and the one or more memory devices are operable to implement the method embodiments described herein. In the various embodiments, the one or more memory devices 106, include memory devices on which data, including computer readable instructions, and other information of the like can reside.

In the embodiment shown in FIG. 1, the printing device 102 can include a printing device driver 108 and a print engine 1112. In various embodiments of FIG. 1, additional printing device drivers can be located off the printing device, for example, on a remote device 110. Such printing device drivers can be an alternative to the printing device driver 108 located on the printing device 102 or provided in addition to the printing device driver 108. As one of ordinary skill in the art will understand, a printing device driver 108 is operable to create a computer readable instruction set for a print job utilized for rendering an image by the print engine 112. Printing device driver 108 includes any printing device driver suitable for carrying out various aspects of the present invention. That is, the printing device driver can take data from one or more software applications and transform the data into a print job.

When a printing device is to be utilized to print an image on a piece of print media, a print job can be created that provides instructions on how to print the image. These instructions are communicated in a Page Description Language (PDL) to initiate a print job. PDL's are high level languages for instructing the printing engine of the printing device to print text and graphics on a particular piece of media. Two major languages currently in use are Adobe's Postscript and Hewlett-Packard's PCL (Print Control Language). The PDL can include a list of printing properties for the print job. Printing properties include, by way of example and not by way of limitation, the size of the image to be printed, its positioning on the print media, resolution of a print image (e.g. Dots Per Inch (DPI)), color settings, simplex or duplex setting, indications to process image enhancing algorithms (e.g. halftoning), and the like.

Some recently developed file formats include bitmaps of the documents they represent. These bitmaps can be sent directly to a print engine without utilizing a printer driver to create a print job. Bitmap files can also be saved directly to a memory storage device for use and/or associated printing at a later time. Examples of bitmap file formats include, but are not limited to, portable document format (PDF), joint photographic experts group (JPEG), and graphics interchange format (GIF).

As shown in the embodiment of FIG. 1, printing device 102 can be networked to one or more remote devices 110 over a number of data links, shown as 122. As one of ordinary skill in the art will appreciate upon reading this disclosure, the number of data links 122 can include one or more physical and one or more wireless connections, and any combination thereof, as part of a network. That is, the printing device 102 and the one or more remote devices 110 can be directly connected and can be connected as part of a wider network having a plurality of data links 122.

In various embodiments, a remote device 110 can include a device having a display such as a desktop computer, laptop computer, a workstation, hand held device, or other device as the same will be known and understood by one of ordinary skill in the art. The remote device 110 can also include one or more processors and/or application modules suitable for running software and can include one or more memory devices thereon.

As shown in the embodiment of FIG. 1, a system 100 can include one or more networked storage devices 114, e.g. remote storage database and the like, networked to the system. Likewise, the system 100 can include one or more peripheral devices 118, and one or more Internet connections 120, distributed within the network.

As one of ordinary skill in the art will appreciate upon reading this disclosure, the network described herein can include any number of network types including, but not limited to a Local Area Network (LAN), a Wide Area Network (WAN), Personal Area Network (PAN), and the like. And, as stated above, data links 122 within such networks can include any combination of direct or indirect wired and/or wireless connections, including but not limited to electrical, optical, and RF connections.

Memory, such as memory 106 and memory 114, can be distributed anywhere throughout a networked system. Memory, as the same is used herein, can include any suitable memory for implementing the various embodiments of the invention. Thus, memory and memory devices include fixed memory and portable memory. Examples of memory types include Non-Volatile (NV) memory (e.g. Flash memory), RAM, ROM, magnetic media, and optically read media and includes such physical formats as memory cards, memory sticks, memory keys, CDs, DVDs, hard disks, and floppy disks, to name a few.

Software, e.g. computer readable instructions, can be stored on such memory mediums. The invention, however, is not limited to any particular type of memory medium. And, the invention is not limited to where within a device or networked system a set of computer instructions is stored on memory for use in implementing the various embodiments of invention.

As stated above, the system embodiment 100 of FIG. 1 includes one or more peripheral devices 118. Peripheral devices can include any number of peripheral devices in addition to those already mentioned herein. Examples of peripheral devices include, but are not limited to, scanning devices, faxing devices, copying devices, modem devices, and the like.

The printing device 102 and the one or more peripheral devices 118 can be individual devices. However, as one of ordinary skill in the art will appreciate upon reading this disclosure, the printing device 102 and the one or more peripheral devices 118, can be combined into a multi-function device. For example, Hewlett Packard produces several devices that provide printing, copying, and scanning. Additionally, some of these multi-function devices also include faxing capabilities. These types of devices are generally referred to as PCS (Printing/Copying/Scanning) devices or as All-in-One (AiO) devices.

As will be explained in more detail below, a mask creation tool, component, or device, can be resident on one or more of the devices described in connection with FIG. 1. Such a mask creation device can also be spread across one or more of the devices described in connection with FIG. 1.

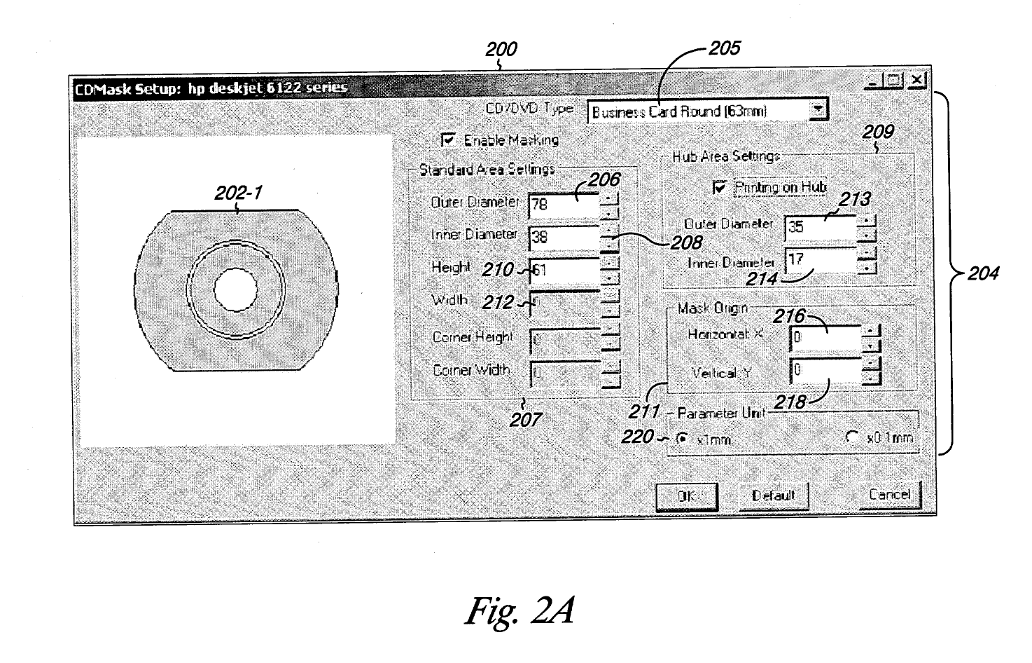

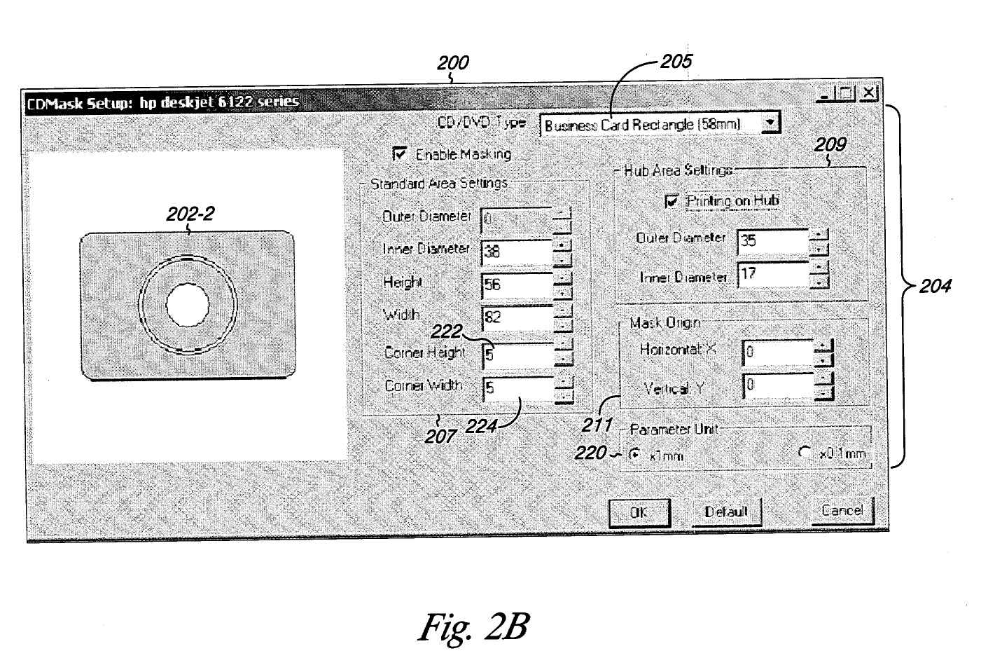

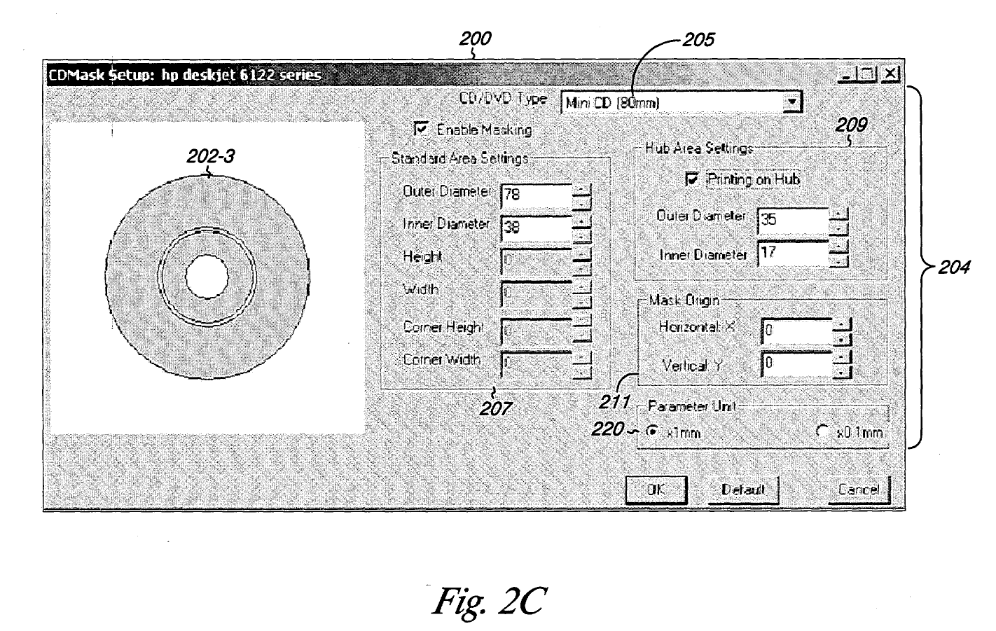

FIGS. 2A-2C illustrate a series of parameter configuration embodiments for generating bitmaps in a masking process. The embodiments shown in FIGS. 2A-2C illustrate a user interface 200, such as a Window provided in a Windows operating system environment. The invention, however, is not limited to a Windows operating system environment, and other operating environments such as LINUX and UNIX, among others can be used.

In the embodiment of FIG. 2A, a nonstandard (e.g. other than an 8 1/2 inch by 11 inch standard page of print media), nonrectangular geometric form/media shape 202-1, such as a CD or DVD, is represented. In various embodiments, the media shape can be obtained using optical sensors interfaced to the masking tool embodiments described herein.

In the embodiment of FIG. 2A, a number of categories 204 parameterizing a geometric form is represented. In this embodiment, the geometric form is the shape of a media type. As used herein, parameterizing a geometric form means categorizing components of the geometric form, e.g., heights, lengths, diameters, margins, borders, and/or other parameters, so that parameter values can be assigned and/or adjusted within each category. In various embodiments, a set of executable instructions is operable to recognize relevant categories associated with a given “parameterized” geometric form. With parameterized geometric forms, dimensions, descriptions, and/or mathematical definition can be variably, and independently adjusted per category to create a mask pattern.

In the embodiment of FIG. 2A, the parameterized categories 204 include media type definition/description 205, standard area settings 207, hub area settings 209, and mask origin 211. In the embodiment of FIG. 2A, parameterizing categories 204 also include a parameter unit setting category 220 used to define the units and/or scale of the dimensions assigned in the other categories. For example, in FIG. 2A millimeters has been selected as the unit at a scale of 1 (“×1 mm”). So, the dimensions selected in the other categories represent millimeters (e.g. hub area outer diameter 213=35 mm, standard area height 210=61 mm). Thus, the embodiments allow a user to assign values to the one or more parameterized categories.

Parameterized categories for other printing properties or attributes associated with a print job could also be used. For example, a category with resolution definition parameters, among others, could be used. Fewer or more than the categories and definable parameters illustrated herein can be utilized as suited to a particular application, e.g. as may or may not be relevant to a given media shape.

In the embodiment of FIG. 2A, the media type definition category 205 allows the user to select/define the particular media type upon which printing is to be performed, e.g. round business card in this embodiment. The standard area settings 207 allows a definition or value to be provided for an outer diameter 206, an inner diameter 208, a height 210, a width 212, as well as a corner height, and corner width where applicable (shown in FIG. 2B as 222 and 224), for the selected media type. The hub area settings 209 allows a definition or value to be provided for an outer diameter 213 and an inner diameter 214 of a hub for the selected media type. The mask origin 211 allows a definition or value to be provided for a horizontal (X) location and a vertical (Y) location to serve as a mask origin reference for the selected media type.

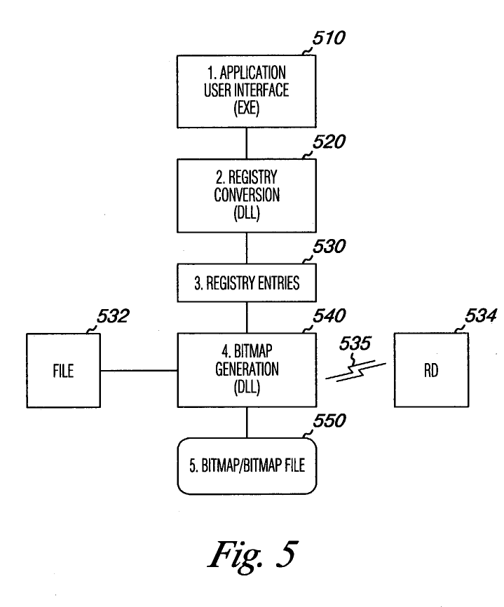

In the various embodiments, categories described above are used to generate a bitmap and/or bitmap file. In various embodiments, the bitmap and/or bitmap file are generated from the values provided in one or more of the above parameterized categories. Bitmaps and/or bitmap files can be generated as described below in connection with FIG. 5. It is noted that generating bitmaps and/or bitmap files from parameterized categories provides a user with the ability to variably adjust a mask pattern from one use to the next without being constrained to a static/template bitmaps. It also, avoids the needs to store volumes of bitmaps or bitmap files.

The parameterized categories provide an adjustability level beyond simply defining a circle of a certain radius. And, the generation of the bitmaps or bitmap files can take advantage of reusing the parameterized categories, on a repeatable basis, without requiring that each particular bitmap or bitmap file be saved in memory.

In various embodiments, the parameterized geometric forms, as described above, are obtained from a data file, or read as a set of instructions for a particular application from a registry, or firmware in an embedded system. In the various embodiments, a bitmap and/or bitmap file created from values assigned in the parameterized categories is used as a printing mask and applied to format a printing area and to position an image on a particular media type and shape, which can be a nonconventional, nonrectangular, and/or nonsymmetrical shape.

FIG. 2B illustrates another nonstandard geometric form/media shape 202-2, such as an ID card or business card. As in the embodiment of FIG. 2A, a number of categories 204 parameterizing the media shape are represented. In the embodiment of FIG. 2B, the categories 204 again include media type 205 (e.g. a business or ID card rectangle), standard area settings 207, hub area settings 209, and mask origin 211. A parameter unit setting category 220 is also shown.

FIG. 2C illustrates another a nonstandard, nonrectangular geometric form/media shape 202-3, such as a CD or DVD. As in the embodiments described above, a number of categories 204 parameterizing the media shape are represented. In the embodiment of FIG. 2C, the categories 204 include media type 205 (e.g. a mini-CD), standard area settings 207, hub area settings 209, and mask origin 211. In the embodiment of FIG. 2C a parameter unit setting category 220 is also shown.

As one of ordinary skill in the art will appreciate upon reading this disclosure, geometric parameter definition for any number of media shapes or media types can be accorded using embodiments described herein.

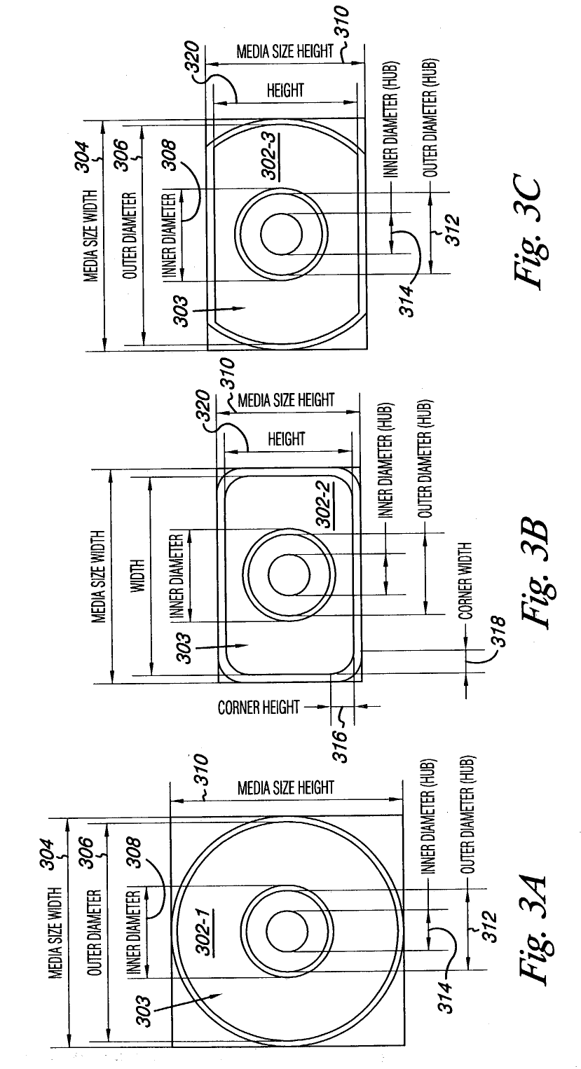

FIGS. 3A-3C illustrate parameters used to describe the media shapes illustrated in FIGS. 2A-2C. That is, definitions or values given in the parameterized categories of FIGS. 2A-2C are illustrated graphically in FIGS. 3A-3C. The geometric form shown in FIG. 3A compares with that shown as 202-3 in FIG. 2C. The geometric form shown in FIG. 3B compares with that shown in FIG. 2B. And the geometric form shown in FIG. 3C compares with that shown in FIG. 2A. As noted above, in various embodiments, a set of executable instructions is operable to recognize relevant categories associated with a given “parameterized” geometric form. Hence, the instructions are operable to parameterize the geometric form. For example, when the geometric form shown in FIG. 3B is selected in category 205 of FIG. 2B, an appropriate set of parameterized categories can be enabled. The invention, however, is not limited to the categories or the parameters shown in FIGS. 2A-2C and FIGS. 3A-3C.

In the embodiment of FIG. 3A a nonstandard, nonrectangular geometric form or media shape 302-1, such as a CD or DVD, is represented. As illustrated in the embodiment of FIG. 3A, the media shape 302-1 includes a parameter of a media size width 304. However, in various printing applications a printing area 303 may not be intended to cover the media size width 304. Accordingly, as shown in the embodiment of FIG. 3A, a parameter is provided for a printing area outer diameter 306 and a printing area inner diameter 308.

As illustrated in the embodiment of FIG. 3A, the media shape 302-1 includes a parameter of a media size height 310. However, in various printing applications a printing area 303 may not be intended to cover the media size height 310. Thus, as shown in the embodiment of FIG. 3C a printing area height 320 can be different from the media size height 310. It is the printing area height 320 which would be entered as a value to the height 210 value or definition in the standard area settings 207 category shown in FIGS. 2A-2C.

As illustrated in the embodiment of FIG. 3A, the media shape 302-1 can include a parameter of an outer diameter 312 and an inner diameter 314 to a hub within the media. In the embodiment illustrated in FIG. 3A, the hub includes an opening portion such as exists for CDs and DVDs. Again, in various printing applications a printing area 303 may not be intended to cover printing to an inner diameter 314, or even to an outer diameter 312 of the hub. Thus, as mentioned above and illustrated in the various embodiments of FIGS. 3A-3C, a parameter for an inner diameter 308 is provided. The invention, however, is not so limited to the type of hub shown in FIG. 3A. Indeed, any interior parameter to a media shape is considered within the scope of embodiments of the present application.

Various parameter embodiments, described herein among others, can be used to generate a bitmap and/or bitmap file. As noted above, however, the invention is not limited to bitmaps and/or bitmap files accessed solely through the use of a graphical user interface (GUI). That is, the parameters illustrated in the embodiments above can be set forth as computer executable instructions in a data file, a particular registry, or firmware in an embedded system, and can be obtained by executing a particular application. Such parameters, and the values assigned/selected for those parameters, reflected in a bitmap and/or bitmap file can be used as a printing mask and applied to format a printing area 303 and to position an image on a particular media type and shape.

FIG. 3B illustrates another nonstandard geometric form or media shape 302-2, such as an ID card or business card, having definable geometric parameters. The embodiment of FIG. 3B, illustrates that a given media shape can further be given a parameter for a corner height 316 and a corner width 318 as part of defining or selecting a particular printing area 303 for the media.

FIG. 3C illustrates another nonstandard, nonrectangular geometric form or media shape 302-3, such as a round business card CD or DVD, having definable geometric parameters.

FIGS. 3A-3C thus help to illustrate the manner is which parameters for numerous geometric forms can provide a user with the ability to variably adjust a mask pattern from one use to the next without being constrained to a static/template bitmaps. Embodiments described herein provide a level of precision, relevant for mask patterns where a printing area may not be intended to cover the entire media shape. Without the parameterized categories defined herein, the process of defining a mask, e.g. selecting a radius of a mask without more related category information, requires trial and error. The parameterized geometric forms, as defined by embodiments herein, provide categorized parameters more intuitively grouped for creating a mask pattern.

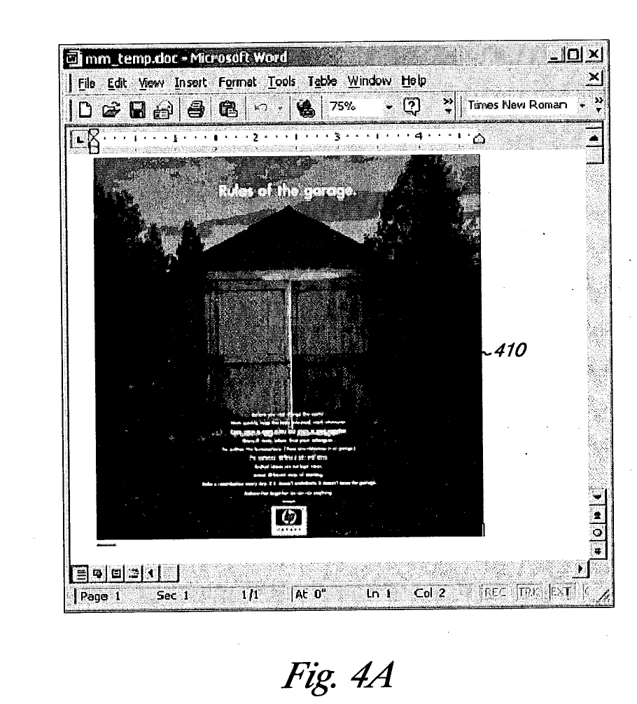

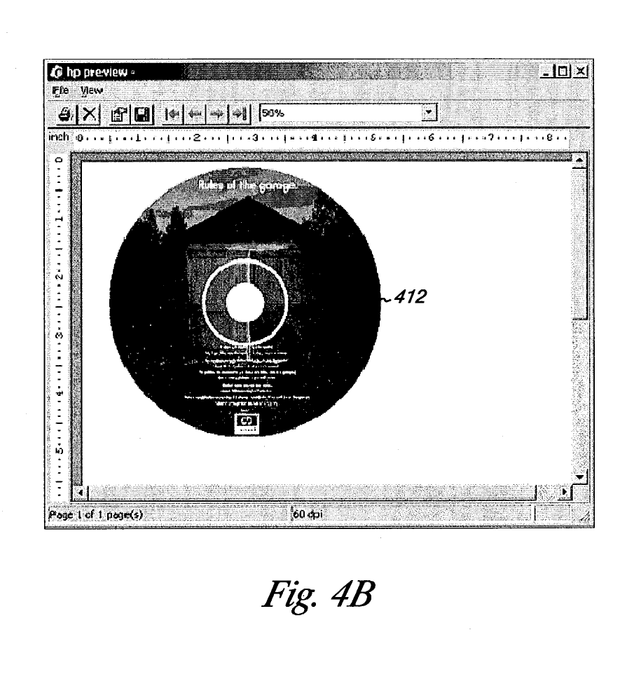

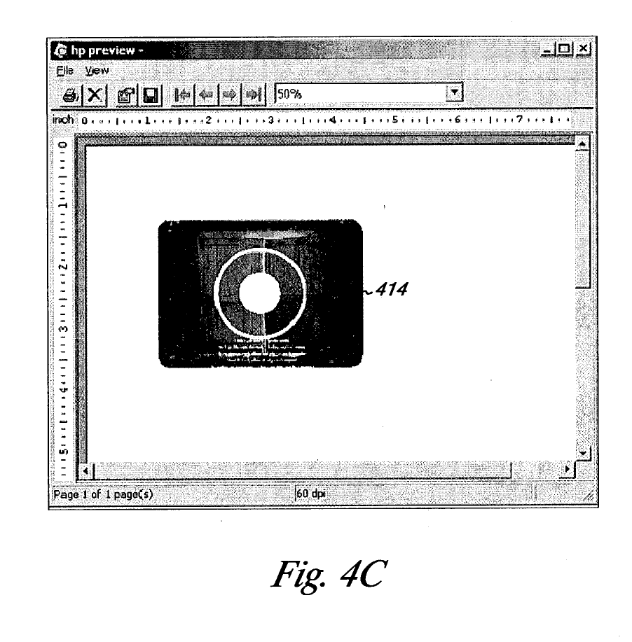

FIGS. 4A-4C illustrate embodiments of a bitmap implementation used to configure images on print media. FIGS. 4A-4C are useful to illustrate the transformation from an initial input image, FIG. 4A, to application on a desired printing area of a particular geometric form or media type, e.g. FIGS. 4B and 4C, through use of a bitmap or bitmap file mask pattern created from values assigned to parameters provided in parameterized categories. FIGS. 4A-4C further illustrates that embodiments include computer executable instructions which are operable to preview, or portray in advance of printing, how an image will appear according to a mask pattern created from the values assigned to parameters provided in parameterized categories. In this manner, if a user is not satisfied with an appearance changes can be made before printing. That is, the values assigned to parameters in the parameterized categories can be easily changed, or the parameters or even the categories can be changed, and a new bitmap or bitmap files generated to revise the appearance. As used herein, changing the values assigned to parameters in the parameterized categories, or changing the parameters or the categories, is referred to as precisioning a mask pattern.

In the embodiment of FIG. 4A an image 410 to be printed on a media is illustrated in a Windows operating environment. As mentioned above, the invention is not limited to a Windows operating environment, nor to using a GUI. The embodiment of FIG. 4A serves as a contextual representation of operating on an image. As one of ordinary skill in the art will appreciate upon reading this disclosure, embodiments can be implemented before, after and/or during image processing. That is, in various embodiments implementation is accorded at the time of, before, and/or after rendering an image.

FIG. 4B illustrates the image 410 from 4A having implemented geometrically defined parameters, such as described above, as a printing mask and as applied to format a printing area and to position an image on a particular media type and shape, e.g. representation 412.

FIG. 4C illustrates another implementation of differently defined geometric parameters, such as described above, as a printing mask and as applied to format a different printing area and to position an image, such as image 410 in FIG. 4A, on a particular media type and shape, e.g. representation 414.

FIGS. 4A-4C illustrate that, in various embodiments, a preview of an image as it will actually appear on a particular media, according to the mask pattern, can be obtained prior to printing. In this manner, wasted print jobs can be obviated.

FIG. 5 illustrates an embodiment of an architecture for generating bitmaps. For example, the architecture embodiment of FIG. 5 can be used for generating bitmaps for use in a masking process in image processing. The invention, however, is not so limited. As one of ordinary skill in the art will appreciate upon reading this disclosure, all or parts of the architecture shown in FIG. 5 may be implemented as a mask creation device or tool. The architecture shown in FIG. 5 can be distributed throughout a system, such as that shown in FIG. 1.

As shown in the embodiment of FIG. 5, embodiments can include an application user interface (AUI) 510. The same, however, is not required. An AUI can be defined by computer executable instructions and can be referred to as an executable file (EXE). A user interface can also take the form of a physical device, such as a PDA, a laptop computer, a printing device itself (with inputs and possibly a display), and/or a cell phone, among others. Accordingly, a user interface can take the form of remote device, such as the remote devices 110 discussed in FIG. 1, In the embodiment of FIG. 5, a AUI EXE 510 is illustrated communicatively interfaced to a registry conversion module 520, such as can be a part of a dynamically linked library (DLL). In various embodiments, a functionality of the AUI 510 includes launching components of the registry conversion module 520. As mentioned above, it is noted that a DLL can be provided in a distributed network system such as that shown in FIG. 1. For example, a DLL can be provided in the one or more network storage devices 114 shown in FIG. 1.

As shown in the embodiment of FIG. 5, the registry conversion module, as part of a DLL or otherwise, is operable to receive registry entries gathered from the AUI 510 or from another source. In the embodiment of FIG. 5, registry entries shown as 530 can be contained in a registry located anywhere within a single device or across a network as shown in FIG. 1. A registry, or register, can receive, transfer and store data, gathered from an application or otherwise, with the aid of a registry conversion module 520. According to embodiments, the registry entries can include parameters provided in the parameterized categories described in connection with FIGS. 2A-2C.

In the embodiment of FIG. 5, the registry entries 530 are interfaced to a bitmap generation module 540. The bitmap generation module 540, or bitmap generator is provided for bitmap generation. That is, the bitmap generator 540 is the component that creates the bitmap that can be used to mask a particular printing area, as associated with a final image for printing. The bitmap generator can include an application programming interface (API) suited to a particular environment in which the bitmap generator is to be used. As illustrated in the embodiment of FIG. 5, the bitmap generation module can be part of a DLL. In various embodiments, the bitmap generation module 540 queries the registry entry 530 for geometric parameters and can calculate a memory size required for a bitmap (e.g. based on the geometric parameters and the resolution). A resolution can be determined according to print modes (e.g. Draft, Normal, or Best, among others).

The bitmap generator 540 allocates the memory, draws the bitmap into memory and provides the bitmap and its related information, such as width, height, size and resolution, to a masking application, e.g. to a printer driver. In various embodiments, when a masking application is done and the memory allocation is not needed anymore, the bitmap generator 540 can free the allocated memory through a callback function.

As shown in the embodiment of FIG. 5, the bitmap's geometric parameters or parameterized geometric forms, e.g. parameters from the parameterized categories described in connection with FIGS. 2A-2C, do not have to come through a register query. In various embodiments, the bitmap generator can obtain the geometric parameters from a data file 532 wherever the same may reside on a network system such as shown in FIG. 1. Again, as used by embodiments herein, the geometric parameters, or parameterized geometric forms, are the parameters which have been provided in parameterized categories. It should be appreciated that the geometric parameters can be provided over either a hardwired (e.g. optical fibers and copper wires, among others), wireless, or combination of hardwired and wireless data links. Thus, as shown in FIG. 5, the bitmap generator can obtain the geometric parameters from a remote device 524 over an air interface, using RF signaling 535 for example.

The embodiment of FIG. 5 illustrates that embodiments for creating a printing mask for various media types and sizes can involve bitmaps and bitmap files 550 provided by embedded systems or over a network. In the embodiments, these bitmaps and bitmap files 550 are created from parameters which have been provided in parameterized categories. Thus, as shown in the embodiment of FIG. 5, a bitmap or bitmap file available over a network or existing in an embedded system can interface with the bitmap generation shown in 540 for creating a mask pattern in a masking process associated with image processing.

The various embodiments facilitate the generation of nonrectangular printing images as needed in particular printing applications, e.g. such as in CD, DVD, and ID card printing systems. In various embodiments, the geometric specification of a monochrome bitmap can be generated using a user interface (UI) application which is operable to specify a geometry of a printing area, including shape and all other parameters. The invention, however, is not so limited. In various embodiments, geometric parameters can be collected from a data file and or can be “embedded” in a system.

Various embodiments thus afford low memory usage, e.g. one bitmap mask can be stored at a time within memory. Added flexibility is provided for implementation with a myriad of applications. Further precision can be achieved due to added control over parameters in parameterized categories. Numerous resolution selections can be chosen for various applications. Embodiments enable a bitmap mask creation which can be used in an image masking process before, after, and/or during image processing. A mask pattern can be created with any shape, e.g. nonrectangular, nonsymmetrical or any form that can be described by geometric parameters. In various embodiments, a bitmap or bitmap file can be created from a Windows format interface increasing user ease of interaction. And, in various embodiments, geometric parameters can be obtained without a user interface. That is, the geometric parameters can be obtained from other data files or can be obtained from embedded systems, e.g. the parameters can be stored in a file or directly in a registry.

One of ordinary skill in the art should appreciate that embodiments described herein can address other applications that require a bitmap mask for identifying existing patterns. That is, a bitmap mask, created according to the embodiments described herein, can be used for like pattern recognition and/or pattern identification. Like pattern recognition and/or pattern identification can have numerous uses such as defect identification, medical diagnosis, security and confidentiality measures, among others. Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for masks in image processing, comprising:
parameterizing a geometric form representing a print media shape; and
generating a bitmap from the parameterized geometric form.

2. The method of claim 1, wherein generating a bitmap from the parameterized geometric form includes converting values assigned to parameterized categories to a bitmap.

3. The method of claim 1, wherein the method further includes using a generated bitmap as a mask pattern to identify an existing pattern.

4. The method of claim 1, wherein the method further includes using a generated bitmap as a mask pattern to match the print media shape.

5. The method of claim 4, wherein using the generated bitmap as a mask pattern to match the print media shape includes matching a nonrectangular, nonsymmetrical print media shape.

6. The method of claim 4, wherein the using the generated bitmap as a mask pattern includes using the generated bitmap directly during an image processing process.

7. A method for image processing, comprising:
categorizing one or more parameters relevant to defining a print area on a print medium;
allowing a user to assign values to the one or more parameters;
converting assigned values to a bitmap.

8. A method for image processing, comprising:
categorizing one or more parameters relevant to defining a print area on a print medium;
assigning values to the one or more parameters;
converting assigned values to a bitmap.

9. A method for masks in image processing, comprising:
parameterizing one or more geometric forms for a particular masking area by providing a number of parameters; and
converting a mathematical description of each parameter to a monochrome bitmap.

10. The method of claim 9, wherein parameterizing one or more geometric forms by providing a number of parameters includes providing a number of parameters to a graphical user interface (GUI).

11. The method of claim 9, wherein the method further includes providing a mathematical description of each parameter.

12. The method of claim 10, wherein the method further includes a user providing a mathematical description to each parameter through the GUI.

13. The method of claim 9, wherein parameterizing one or more geometric forms by providing a number of parameters includes providing one or more of the following;
a media type parameter;
standard area settings parameters;
hub area settings parameters;
a mask origin parameter;
a parameter unit setting parameter, and
a resolution setting parameter.

14. The method of claim 9, wherein parameterizing geometric forms includes precisioning a mask pattern to a particular printing area within the particular masking area.

15. The method of claim 9, wherein converting a mathematical description of each parameter to a monochrome bitmap includes creating a bitmap file.

16. The method of claim 9, wherein the method further includes storing a number of parameters for a particular media shape in a registry.

17. A computer readable medium having a set of computer executable instructions operable to cause a device to perform a method, the method comprising:
parameterizing a geometric form representing a print media shape; and
generating a bitmap from the parameterized geometric form.

18. The medium of claim 17, wherein generating a bitmap from the parameterized geometric forms includes converting values assigned to category parameters to a bitmap.

19. A computer readable medium having a set of computer executable instructions operable to cause a device to perform a method, the method comprising:
categorizing one or more parameters relevant to defining a print area on a print medium;
allowing a user to assign values to the one or more parameters;
converting assigned values to a bitmap.

20. A computer readable medium having a set of computer executable instructions operable to cause a device to perform a method, the method comprising:
categorizing one or more parameters relevant to defining a print area on a print medium;
assigning values to the one or more parameters;
converting assigned values to a bitmap.

21. A computer readable medium having a set of computer executable instructions operable to cause a device to perform a method, the method comprising:
parameterizing one or more geometric forms for a particular masking area by providing a number of parameters; and
converting a mathematical description of each parameter to a monochrome bitmap.

22. The medium of claim 21, wherein parameterizing one or more geometric forms by providing a number of parameters includes providing a number of parameters to a graphical user interface (GUI).

23. The medium of claim 22, wherein the method further includes a user providing a mathematical description to each parameter through the GUI.

24. A computer readable media having a set of computer executable instructions operable to cause a device to perform a method, the method comprising:
obtaining a parameterized geometric form representing a printing area for a print media; and
applying the parameterized geometric form as a mask pattern.

25. The medium of claim 24, wherein applying the parameterized geometric form as a mask pattern includes printing an image on the printing area of the print media according to the mask pattern.

26. The medium of claim 25, wherein the method further includes previewing the image on a representation of the print media prior to printing.

27. A mask creation device, comprising;
one or more inputs; and
a means for parameterizing a geometric form representing a print media shape; and
a means for generating a bitmap from the parameterized geometric form.

28. The device of claim 27, wherein the one or more inputs include a registry.

29. The device of claim 27, wherein the one or more inputs include a data file.

30. The device of claim 27, wherein the one or more inputs include a wireless communication channel operable to receive signals from a remote device.

31. The device of claim 27, wherein the means for generating a bitmap includes computer readable instruction to access a number of registry entries and to provide the number of registry entries to a bitmap generator.

32. A mask creation architecture, comprising;
a bitmap retrieval system; and
a bitmap generator operable on bitmaps provided by the bitmap retrieval system to create a precision mask pattern which defines a printing area within a print media shape.

33. The architecture of claim 32, wherein the bitmap retrieval system includes;
a registry;
a registry conversion module operably coupled to the registry; and
a user interface operably coupled to the registry conversion module.

34. The architecture of claim 33, wherein the registry conversion module is operable to convert geometric parameters entered to the user interface to one or more registry entry values.

35. The architecture of claim 32, wherein the bitmap retrieval system includes a network link to an embedded system having bitmaps thereon.
